(19) United States
(12) Patent Application Publication
(10) Pub. No.: US 2016/0178574 A1
(43) Pub. Date: Jun. 23, 2016

(54) TEST STRIP AND METHOD TO DETERMINE TEST STRIP COMPATIBILITY

(71) Applicant: Cilag GmbH International, Zug (CH)

(72) Inventors: Leanne MILLS, Croy (GB); Gavin MACFIE, Inverness (GB); Marco CARDOSI, Croy (GB); Michael ROBERTS, Inverness (GB)

(21) Appl. No.: 14/573,351

(22) Filed: Dec. 17, 2014

(51) Int. Cl. G01N 27/417; G01N 27/327

(52) U.S. Cl. CPC G01N 27/4175; G01N 27/3272; G01N 27/3274

(57) ABSTRACT

An analyte measurement system is disclosed herein. The analyte measurement system includes a test strip. The test strip includes at least two electrodes spaced apart in a reaction chamber, one of said electrodes including a conductive material having a coating applied thereupon. The analyte measurement system also includes an analyte measurement device. The analyte measurement device includes a strip port having connectors configured to coupled to the electrodes of the test strip. The applied coating enables a capacitance value of the test strip to be measured in order to determine compatibility of the test strip with the analyte measurement device.

### TECHNICAL FIELD

This application generally relates to the field of analyte measurement systems and more specifically to portable analyte meters that are configured to determine the compatibility of a test strip therewith.

### BACKGROUND

Analyte concentration determination in physiological fluids (e.g., blood or blood derived products such as plasma) is of ever increasing importance in today's society. Such determinations find use in a variety of applications and settings, including clinical laboratory testing, home testing, etc., where the results of such testing play a prominent role in the diagnosis and management of a variety of disease conditions. Analytes of interest include glucose for diabetes management, cholesterol for monitoring cardiovascular conditions, and the like. In response to this growing importance of analyte detection, a variety of analyte detection protocols and devices for both clinical and home use have been developed. These devices can include electrochemical cells, electrochemical sensors, hemoglobin sensors, antioxidant sensors, biosensors, and immunosensors.

A common method for determining analyte concentration in assays is based on electrochemistry. In such methods, an aqueous liquid sample is placed into a sample reaction chamber in a biosensor, such as an analytical test strip having an electrochemical cell made up of at least two electrodes, i.e., a working electrode and a counter electrode, the electrodes having an impedance that renders them suitable for amperometric or coulometric measurement. In brief, the sample to be analyzed is allowed to react with a reagent disposed on one electrode to form an oxidizable (or reducible) substance in an amount proportional to the analyte concentration following the application of at least one test potential (voltage). The quantity of the oxidizable (or reducible) substance present is then estimated electrochemically and related to the analyte concentration in the sample.

Because many of these analyte determination systems are portable, and testing may be completed in a short amount of time, patients are able to use such devices in the normal course of their daily lives without significant interruption to their personal routines. As a result, a person with diabetes may measure their blood glucose levels several times a day as a part of a self management process to ensure glycemic control of their blood glucose within a target range. A failure to maintain target glycemic control may result in serious diabetes-related complications including cardiovascular disease, kidney disease, nerve damage and blindness.

There currently exist a number of available portable electronic analyte measurement devices that are designed to automatically activate upon insertion of a test strip into a port of the device, e.g., a test meter. Electrical contacts, or prongs, in the test meter establish connections with contact pads provided on the test strip. However, test strips for these analyte measurement devices cannot be differentiated because the analyte measurement devices cannot determine if the test strip is compatible with the test meter. Because of this inability to determine compatibility, a user may unknowingly use an incompatible test strip with an analyte measurement device and receive and inaccurate result.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A is a top perspective view of an exemplary test strip in accordance with the prior art;

FIG. 1B is an exploded assembly view of the exemplary test strip of FIG. 1A;

FIG. 1C is a side elevational view, in section, of the exemplary test strip of FIG. 1A;

FIG. 2A is a representation of a known coating for use in the test strip of FIGS. 1A-1C;

FIG. 2B is a representation of an exemplary electrode coating in accordance with the invention;

FIG. 2C is a representation of another exemplary electrode coating;

FIG. 3A is a schematic comparative plot of test strip batches comparing measured capacitance values based on the presence of at least one electrode coating;

FIG. 3B depicts a schematic analyte concentration determination comparing test strip batches having different electrode coatings;

FIG. 4A illustrates an exemplary analyte measurement device;

FIG. 4B illustrates a test strip coupled to the analyte measurement device;

FIG. 5 illustrates an exemplary test potential waveform used by an analyte measurement device for applying a plurality of test potentials for predetermined time intervals to a test strip; and

FIG. 6 illustrates a flow chart of an exemplary method for determining compatibility of a test strip with an analyte measurement device.

### MODES OF CARRYING OUT THE INVENTION

The following detailed description should be read with reference to the drawings, in which like elements in different drawings are identically numbered. The drawings, which are not necessarily to scale, depict selected embodiments and are not intended to limit the intended scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “patient” or “user” refer to any human or animal subject and are not intended to limit the systems or methods to human use, although use of the subject invention in a human patient represents a preferred embodiment.

The term “sample” means a volume of a liquid, solution or suspension, intended to be subjected to qualitative or quantitative determination of any of its properties, such as the presence or absence of a component, the concentration of a component, e.g., an analyte, etc. The embodiments of the present invention are applicable to human and animal samples of whole blood. Typical samples in the context of the present invention as described herein include blood, plasma, red blood cells, serum and suspensions thereof.

The terms “about” and “substantially” are used in connection with a numerical value throughout the description and claims denotes an interval of accuracy, familiar and acceptable to a person skilled in the art. The interval governing this term is preferably +20%. Unless specified, the terms described above are not intended to narrow the scope of the invention as described herein and according to the claims.

Certain exemplary embodiments will now be described to provide an overall understanding of the principles of the structure, function, manufacture, and use of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

As will be discussed in more detail below, the disclosed systems and methods include detecting the insertion of a test strip in an analyte measurement device, the test strip having first and second electrodes in a spaced relationship; applying a first test potential between the electrodes for a first predetermined time interval; measuring a capacitance value; comparing the measured capacitance value to stored or predetermined capacitance value; and determining, based on comparison between the measured capacitance value and the expected capacitance value, the compatibility of the test strip with the analyte measurement device.

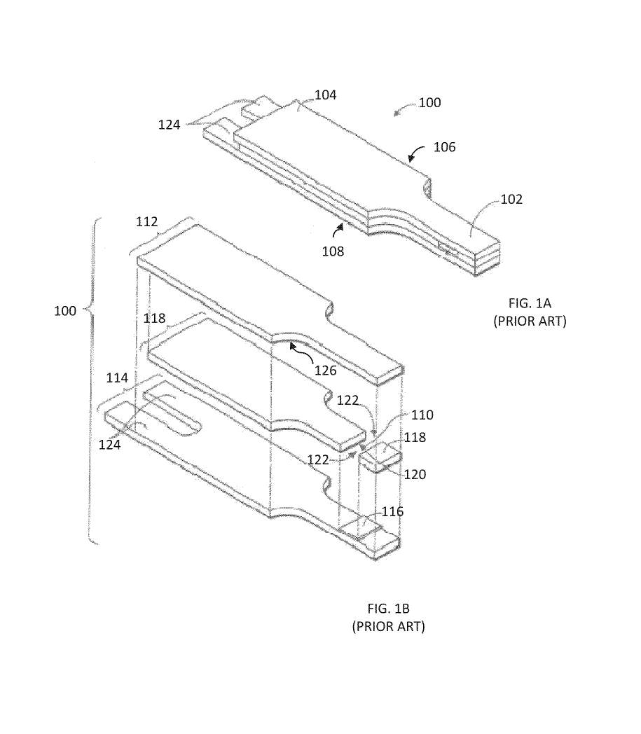

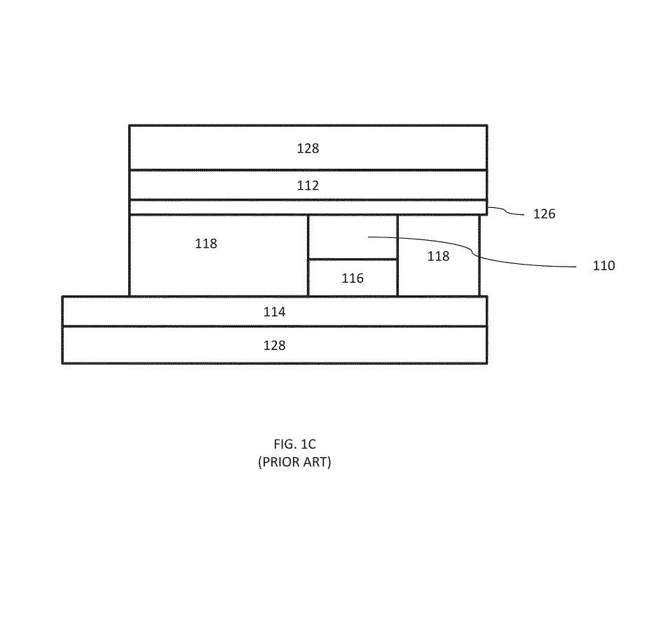

FIGS. 1A-1C show various views of an exemplary analytical test strip 100. As shown, the test strip 100 may include an elongate body extending from a distal end 102 to an opposing proximal end 104, and having lateral edges 106, 108. In this embodiment, the distal 102 of the body includes a sample reaction chamber 110 having multiple electrodes 112, 114 and a reagent 116 which is applied to one of the electrodes, while the proximal end 104 of the test strip body may include features, such as contact pads 124, that are configured for electrically communicating with a analyte measurement device (not shown). As used herein, the term “proximal” indicates that a reference structure is closer to the analyte measurement device and the term “distal” indicates that a reference structure is further away from the analyte measurement device.

In the illustrative embodiment and as shown in FIG. 1B, the test strip 100 is defined by a first electrode layer 112 and a second electrode layer 114, with a spacer layer 118 being positioned therebetween. The sample reaction chamber 110 is defined by the first electrode 112, the second electrode 114, and a spacer 118 as shown in FIGS. 1A-1C forming a spaced apart configuration. Specifically, the first electrode 112 and the second electrode 114 define respective top and bottom sides of the sample reaction chamber 110. A cutout area 120 of the spacer layer 118 may define the side walls of the sample reaction chamber 110. In one aspect, the sample reaction chamber 110 may further include a number of ports 122 that define or otherwise form a sample inlet and/or a vent. For example, one of the ports 122 may provide a fluid sample ingress and the opposing port 122 may act as a vent.

In use, physiological fluid or a control solution may be delivered to the sample reaction chamber 110 for electrochemical analysis. The sample reaction chamber 110 of the test strip 100 may have a small volume. For example, the volume may range from about 0.1 microliters to about 5 microliters, preferably about 0.2 microliters to about 3 microliters, and more preferably about 0.3 microliters to about 1 microliter. As will be appreciated by those skilled in the art, the sample reaction chamber 110 may be suitably configured and sized to enable other volumes. To provide the small sample volume, the cutout area 120 may have an area ranging from about 0.01 cm² to about 0.2 cm², preferably about 0.02 cm² to about 0.15 cm², and more preferably about 0.03 cm² to about 0.08 cm². Similarly, those skilled in the art will appreciate that the volume cutout area 120 may be appropriately sized. In addition, the first and second electrode 112, 114 may be spaced in the range of about 1 micron to about 500 microns, preferably in the range of about 10 microns to about 400 microns, and more preferably in the range of about 40 microns to about 200 microns. In other embodiments, such a range may vary between various other values. According to this exemplary embodiment, the spacing between the electrodes 112, 114 allows reduction/oxidation cycling to occur, where an oxidized mediator generated at the first electrode 112, diffuses to the second electrode 114 to become reduced, and subsequently diffuses back to the first electrode 112 to become oxidized again under the application of at least one test potential.

A quantity of the fluid sample of interest may be introduced into the test strip 100, and more specifically the electrochemical cell that includes the first electrode 112, the second electrode 114, and a reagent layer 116. The fluid sample may be whole blood or a derivative or fraction thereof, or a control solution. The fluid sample, e.g., blood, may be dosed into the sample reaction chamber 110 via the port 122. In one aspect, the port 122 and/or the sample reaction chamber 110 may be configured such that capillary action causes the fluid sample to fill the sample reaction chamber 110.

At the proximal end 104 of the test strip body 100 and according to this exemplary embodiment, electrical contacts 124 may be used to establish an electrical connection to an analyte measurement device. Applicants note that the test strip 100 may include a variety of alternative electrical contacts configured for electrically connecting to a analyte measurement device.

Each of the first electrode layer 112 and/or the second electrode layer 114 can be formed from a conductive material such as gold, palladium, carbon, silver, platinum, tin oxide, iridium, indium, and combinations thereof (e.g., indium doped tin oxide). In terms of forming, electrode layers 112, 114 may be formed by disposing a conductive material onto an insulating sheet (not shown) by various processes such as, for example, a sputtering, electroless plating, or a screen printing process. In the herein described, the first electrode layer 112 may be a sputtered gold electrode and the second electrode layer 114 may be a sputtered palladium electrode. Suitable materials that may be employed as the spacing layer 118 include various insulating materials, such as, for example, plastics (e.g., PET, PETG, polyimide, polycarbonate, polystyrene), silicon, ceramic, glass, adhesives, and combinations thereof. The first electrode 112 and the second electrode 114 may further include an exterior coating 128, as illustrated in FIG. 1C, to protect the electrodes 112, 114 from reacting with an external environment. Any suitable material may further include an insulating material, such as a plastic.

A reagent layer 116 may be disposed within the sample reaction chamber 110 onto one of the spaced apart electrodes 112, 114 using a process such as slot coating, dispensing from the end of a tube, ink jetting, screen printing, or any other suitable process. In one embodiment, the reagent layer 116 may include at least a mediator and an enzyme, and may be deposited onto the second electrode 114. Various mediators and/or enzymes are intended to be within the spirit and scope of the present disclosure. For example, suitable mediators include ferricyanide, ferrocene, ferrocene derivatives, osmium bipyridyl complexes, and quinone derivatives. Examples of suitable enzymes include glucose oxidase, glucose dehydrogenase (GDH) based on pyrroloquinoline quinone (PQQ) co-factor, GDH based on nicotinamide adenine dinucleotide co-factor, and FAD-based GDH [E.C.1.1.99.10].

Either the first electrode 112 or the second electrode 114 may function as a working electrode which oxidizes or reduces a limiting amount of mediator of the reagent layer 116 depending on the polarity of an applied test potential of the analyte measurement device. For example, if the current limiting species is a reduced mediator, it may be oxidized at the second electrode 114 as long as a sufficiently positive potential was applied with respect to the first electrode 112. In the latter instance, the second electrode 114 performs the function of the working electrode and first electrode 112 performs the function of a counter/reference electrode. It should be noted that unless otherwise stated for test strip 100, all potentials applied by analyte measurement device 100 will hereinafter be stated with respect to the first electrode 112. Similarly, if a sufficiently negative potential is applied with respect to the first electrode 112, then the reduced mediator may be oxidized at the first electrode 112. In such a situation, the first electrode 112 may perform the function of the working electrode and the second electrode 114 may perform the function of the counter/reference electrode. Additional details regarding the features of the exemplary test strip can be found in pending International Patent Application No. PCT/US2010/062629, entitled “Systems and Methods for High Accuracy Analyte Measurement”, published as International Patent Application Publication No. WO 2012/091728, the entirety of which is herein incorporated by reference.

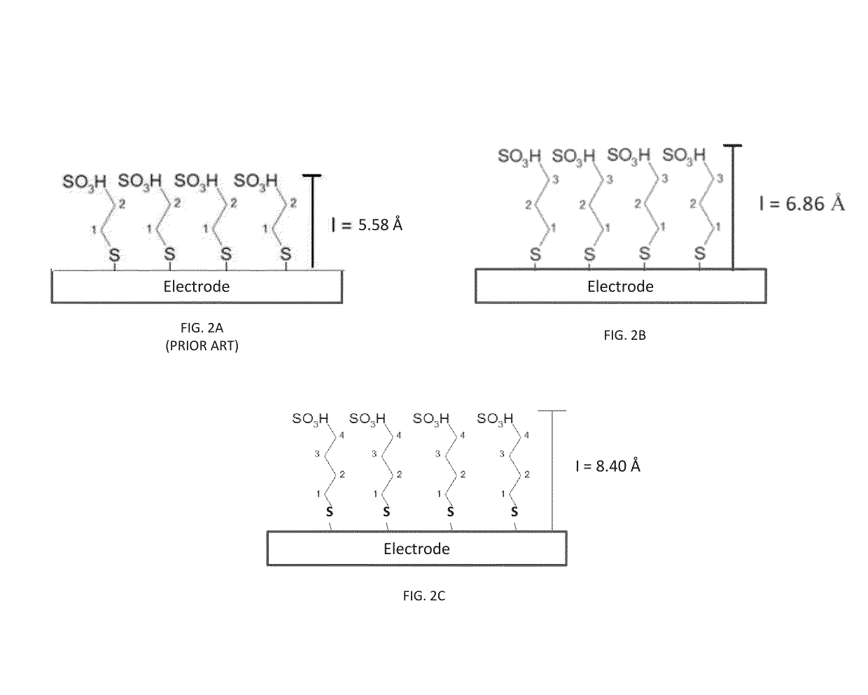

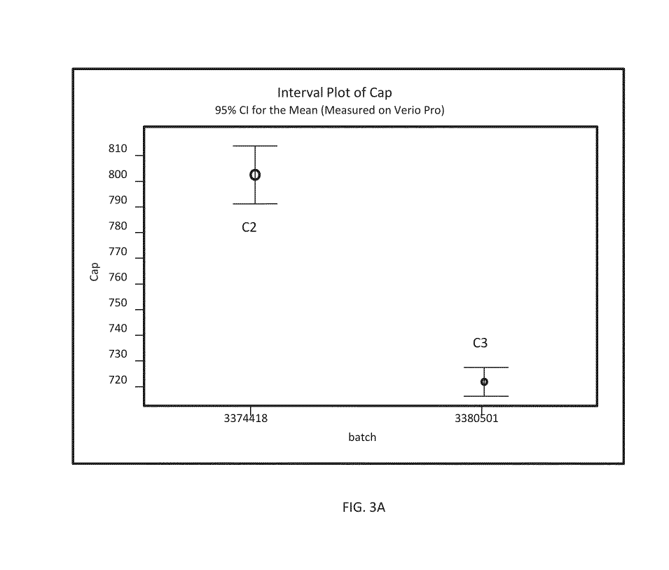

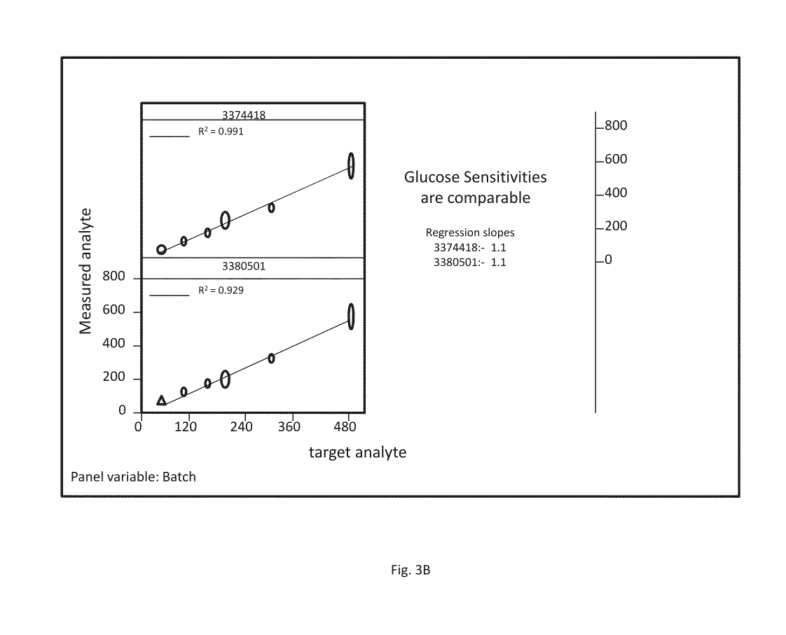

With reference to FIG. 1C, the test strip 100 further includes a coating 126. The coating 126 is a self-assembled monolayer (SAM) which is applied to render the surface of the first electrode 112 hydrophilic, aiding filling. More specifically, the coating 126 can be a thiol compound. This thiol compound includes an alkyl chain having two carbon atoms. For example, and with reference to FIG. 2A, the thiol compound is typically sodium-2-mercaptoethane sulfonate (MESA) including two carbon atoms, as illustrated in FIG. 2A. In addition to rendering the surface of the first electrode 112 hydrophilic, the coating 126 also impacts the double layer capacitance of the electrode/sample interface, which will be further discussed with regards to FIGS. 2A-2C. The composition of the coating 126 can be selected based on a desired predetermined (expected) capacitance measurement. Using this predetermined capacitance measurement, an analyte measurement device in which the test strip is inserted can determine if the test strip is compatible with the analyte measurement device. However, and as discussed herein, the applied coating 126 does not affect analysis of the sample or otherwise impact the effective results.

The coating 126 can be applied to the first electrode 112 in any suitable manner. For example, the coating 126 can be applied with a bath of a dilute solution of the coating material (MESA, MPSA, MBSA, etc.). For example, a film of the electrode material can be passed through the solution of coating material at a predetermined speed and/or concentration, resulting in a thin layer of coating solution being adhered to the surface of the electrode film. The speed of the electrode material through the coating solution can be determined based on a desired thickness of the applied coating. While a particular coating process is described here, any suitable coating process can be employed. Note that while the coating 126 is illustrated in FIG. 1C, in practical applications coating 126 is too thin to be ordinarily perceived by the naked eye.

FIGS. 2A-2C illustrate exemplary electrode coatings shown schematically and for purposes of comparison. FIG. 2A illustrates a coating of sodium-2-mercaptoethane sulfonate (MESA), typically used as a coating for the electrode. However, Applicants have determined that additional thiol compounds are suitable for use as the coating. By employing various thiol compounds, compatibility of test strips with analyte measurement devices can be determined. Examples of these additional thiol compounds are illustrated by FIGS. 2B-2C. As illustrated by FIG. 2B, MESA is a thiol compound that is defined by a two carbon alkyl chain. The length of the molecule, estimated by computational methods, is approximately 5.58 Angstroms (Å). FIG. 2B illustrates a coating of sodium-2-mercaptoethane sulfonate (MPSA). MPSA is an alkyl thiol with properties similar to MESA. However, MPSA is defined by a three carbon alkyl chain. Because of this extra carbon atom, MPSA is slightly longer than MESA, with an estimated molecular length of 6.86 Å. FIG. 2C illustrates a coating of sodium-2-mercaptobutane sulfonate (MBSA). MBSA, another thiol compound, is defined by a four carbon alkyl chain, rendering MBSA longer than both MESA and MPSA with an estimated molecular length of 8.40 Å.

It has been determined by Applicants that the measured capacitance of the test strip, such as test strip 100, is directly related to the molecular length of the applied coating 126. Consider a solution including only an inert electrolyte (no faradaic redox couple), in which no charge passes across the electrode-solution interface over a given range of potential. Under these conditions, a change in potential at the working electrode from its equilibrium value causes a charge imbalance across the interface which must be neutralized by rearrangement of charged species in the solution near the electrode surface. In this sense, the interfacial region may be represented by the two plates of a capacitor, whose capacitance is described by:

$$\frac{q}{E} = C \qquad ( Equation 1 )$$

where q is the charge in Coulombs stored on the capacitor, E is the potential across the capacitor in volts, and C is the capacitance in Farads (F). Each time the potential at the electrode is changed, charge will flow (current) at the interface until the capacitance equation above has been satisfied, resulting in what is referred to as a charging current.

The structure of the “double layer” actually contains several layers on the solution side, whose thickness and composition may affect electron transfer to faradaic solution species. If there are charged species that are immobilized onto the electrode surface, these charged species will also contribute to the structure of the charged interface where the distance that they lie from the electrode surface becomes important.

The double layer capacitance of an electrical interface may be modulated in part by the presence of surface bound organic molecules containing aliphatic side chains. The double layer capacitance at a metal/liquid interface is given by the following relationship:

$${C}_{dl} = {ɛ}_{0} ɛ \frac{A}{l} \qquad ( Equation 2 )$$

where C_{d1} is the double layer capacitance, c is the dielectric constant of the surface adsorbate, l is the length of the surface bound species, A is the area of the metal, and ∈₀ is the permittivity of free space.

From Equation 1, it is evident that the C_{d1} of the interface may be modulated by changing the length of the surface bound adsorbate. In simple terms, as the length of the species increases, so the double layer capacitance decreases in a monotonic and predictable manner. Accordingly, as further illustrated by FIGS. 3A-3B, as the length of MPSA is greater than the length of MESA, the capacitance of an electrode coated with MPSA will consequently be lower than the capacitance of an electrode that is coated with MESA. Similarly, the capacitance of an electrode that is coated with MBSA, which is longer than both MESA and MPSA, will be lower than the capacitance of an electrode that is coated with either MESA or MPSA.

FIGS. 3A-3B illustrate the results of a comparison of capacitance of test strips in which similarly formed electrodes coated with MESA and MPSA, respectively. For purposes of this comparison, two (2) batches of test strips, such as those of FIG. 1C, were manufactured using standard manufacturing methods. In batch 3374418, the top electrode was coated with MESA and in batch 33102501, the top electrode was coated with MPSA. The functional concentrations of MESA and MPSA present in the coating baths were the same, i.e., 0.3 mM. For both batches, the web speed through the bath was 6 m/min. For purposes of this comparison, a total of one hundred (100) determinations were carried out for each batch.

The initial assessment of double layer capacitance was performed using a proprietary surrogate plasma solution containing water, salts, and albumin. Aliquots of solution were dosed into the manufactured test strips and the capacitance was recorded using a VerioPro™ analyte meter. As predicted by Equation 2, the capacitance of the batch of test strips in which the electrodes were treated with MPSA was lower than the capacitance of the test strips in which the electrodes were treated with MESA. When the experiment was repeated with venous blood, a similar outcome was obtained. With two meters with different capacitance thresholds, for example, such that meter A expected a test strip capacitance value greater than 750 nF and meter B expected a capacitance threshold less than 750 nF, there would be no possible way that an incorrect batch could be used in the wrong meter. Batch 3374418 (MESA coating) would only pass the capacitance test in Meter A (C_{d1} greater than 750 nF) and Batch 3310251 (MPSA) would only pass the capacitance test in Meter B (C_{d1} less than 750 nF).

As illustrated by FIG. 3B, modification of the top electrode with MPSA does not affect the overall response of the test strip in regard to a determination of whole blood glucose. As such, replacing the MESA coating with MPSA coating does not affect analysis of the analyte. During testing, both batches produced 100% correct identification of the sample, both with the control sample and the glucose sample. Further, as seen in FIG. 3B, when the sensitivity of the two batches to glucose are compared, the exact slopes obtained from a whole blood calibration are identical for both batches. These identical slopes indicate that the use of MPSA, rather than MESA, does not in any way impact the response of the test strip to whole blood glucose. As such, the use of MPSA does not impact the ability of the analyte meter to distinguish between a control solution and whole blood.

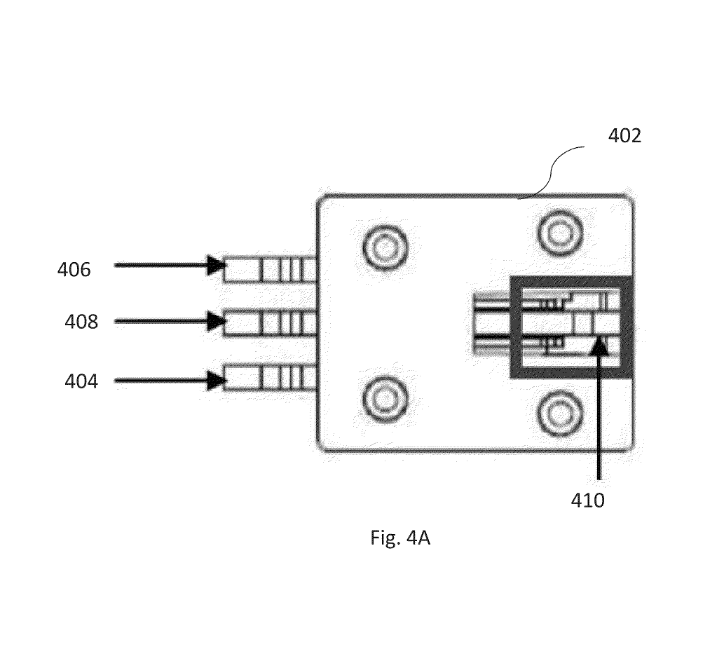

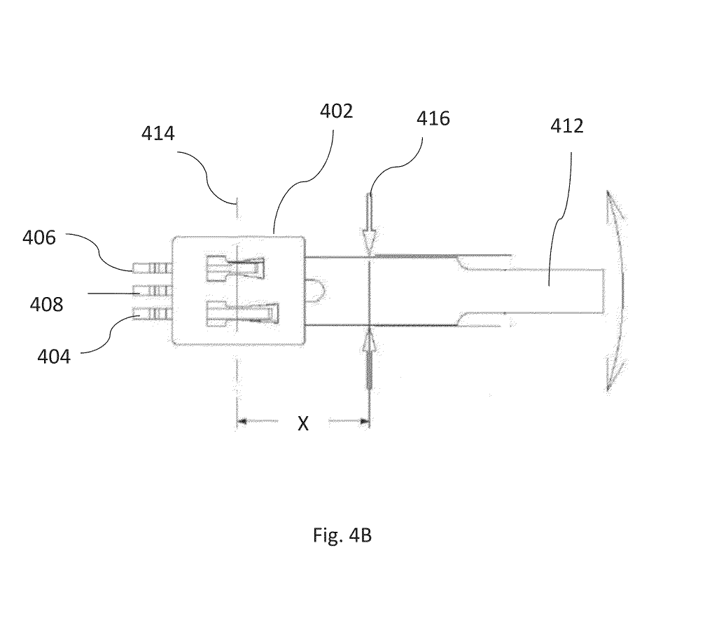

FIGS. 4A-4B illustrate interaction of a test strip with the strip port connector of an analyte measurement device to measure capacitance. An exemplary analyte measurement device is described in pending International Patent Application No. PCT/US2010/062629, entitled “Systems and Methods for High Accuracy Analyte Measurement”, published as International Patent Application Publication No. WO 2012/091728, the entirety of which is herein incorporated by reference. An exemplary strip port connector 402 includes two contacts or prongs 404, 406 configured to interface with the bottom electrode of the test strip and a center contact 408 to interface with the top electrode including the coating 126, illustrated in FIG. 1C. The contact 408 contacts the top gold electrode through a spacer gap 410. The test strip 412, similar to the test strip illustrated in FIG. 1C, is inserted in the measurement device 402 and stopped at an internal hard stop 414. A pinch point 416, located at a distance x from the internal hard stop 414, controls lateral movement of the strip 412. The distance x is determined by the design of the strip port connector 402.

Upon insertion of the test strip 412 in the analyte measurement device 402, the capacitance of the test strip may be measured. The capacitance measurement may measure essentially an ionic double-layer capacitance resulting from the formation of ionic layers at the electrode-liquid interface. A magnitude of the capacitance may be used to determine whether a sample is a control solution or a blood sample. For example, when a control solution is within the reaction chamber, the magnitude of the measured capacitance may be greater than the magnitude of the measured capacitance when a blood sample is in the reaction chamber. As will be discussed in more detail below, a measured capacitance may be used in various methods to correct for the effects of changes in a physical property of the test strip on measurements made using the test strip. For example, changes in the measured capacitance may also be related to at least one of an age of the test strip and a storage condition of the test strip.

In one exemplary method for measuring capacitance, a test voltage having a DC voltage component and an oscillating AC voltage component is applied to the test strip. In such an instance, the resulting test current may be mathematically processed, as described in further detail below, to determine a capacitance value.

Generally, when a limiting test current occurs at a working electrode having a well-defined area (i.e., an area not changing during the capacitance measurement), the most accurate and precise capacitance measurements in an electrochemical test strip may be performed. A well-defined electrode area that does not change with time may occur when a tight seal is present between the electrode and the spacer. The test current is relatively constant when the current is not changing rapidly due either to analyte oxidation or electrochemical decay. Alternatively, any period of time when an increase in signal, which would be seen due to analyte oxidation, is effectively balanced by a decrease in signal, which accompanies electrochemical decay, may also be an appropriate time interval for measuring capacitance.

An area of the second electrode 114 may potentially change with time after dosing with the sample if the sample seeps in between the spacer 118 and the second electrode 114, resulting in leakage. In an embodiment of a test strip, the reagent layer 116 may have an area larger than the cutout area 120 that causes a portion of the reagent layer 116 to be between the spacer 118 and the second electrode layer 114. Under certain circumstances, interposing a portion of the reagent layer 116 in between the spacer 118 and the second electrode layer 114 may allow the wetted electrode area to increase during a test. As a result, leakage may occur during a test causing the area of the second electrode to increase with time, which in turn may distort or adversely affect a capacitance measurement.

In contrast, an area of the first electrode 112 may be more stable with time compared to the second electrode 114 because no reagent layer is present between the first electrode 112 and the spacer 118. Thus, an introduced sample is less likely to seep between the spacer 118 and the first electrode 112. A capacitance measurement that uses a limiting test current at the first electrode 112 may thus be more precise because the fill area does not change during the test.

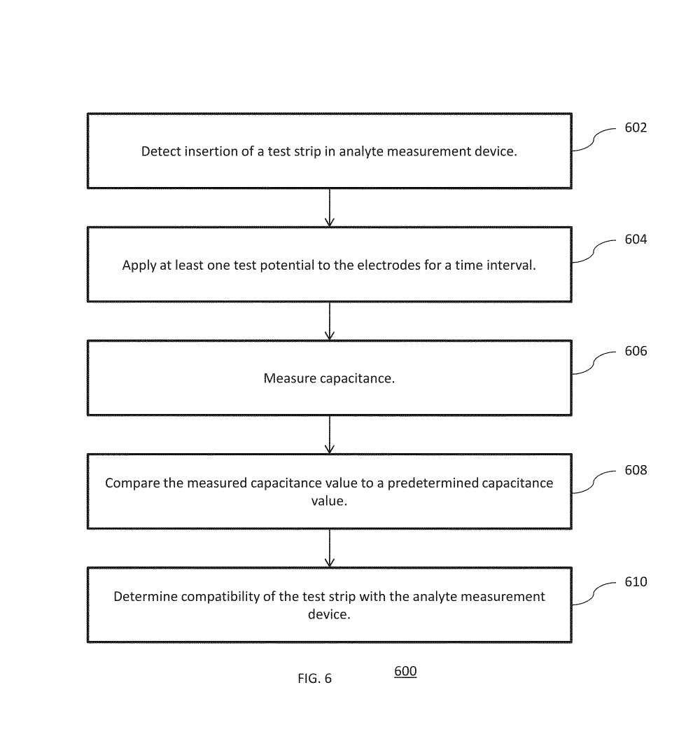

As discussed above and as shown in FIG. 6, once liquid is detected in the test strip, a first test potential E₁ (e.g., about 20 mV, as illustrated in FIG. 6) may be applied between the electrodes for about 1 second to monitor the fill behavior of the liquid and to discriminate between a control solution and a blood sample. Additional details regarding the testing potentials can be found in pending International Patent Application No. PCT/US2010/062629, entitled “Systems and Methods for High Accuracy Analyte Measurement”, published as International Patent Application Publication No. WO 2012/091728, the entirety of which is herein incorporated by reference. In Equation 3 (below), test currents are measured from about 0.05 to about 1 second. This first test potential E₁ may be sufficiently low voltage such that the distribution of ferrocyanide in the electrochemical cell is disturbed as little as possible by the electrochemical reactions occurring at the first and second electrodes.

In this embodiment, a second test potential E₂ (e.g., about 300 mV, as illustrated in FIG. 6) having a larger absolute magnitude is applied after the first test potential E₁ such that a limiting current may be measured at the first electrode 112. The second test potential E₂ included an AC voltage component and a DC voltage component. The AC voltage component may be applied at a predetermined amount of time after the application of the second test potential E₂, and further, may be a sine wave having a frequency of about 109 Hertz and an amplitude of about +/−50 millivolts. In a preferred embodiment, the predetermined amount of time may range from about 0.3 seconds to about 0.4 seconds after the application of the second test potential E₂. Alternatively, the predetermined amount of time may be a time where a test current transient as a function of time has a slope of about zero. In another embodiment, the predetermined amount of time may be a time required for a peak current value (e.g., i_{pb}) to decay by about 50%. The DC voltage component may be applied at the beginning of the second test potential. The DC voltage component may have a magnitude sufficient to cause a limiting test current at the second electrode such as, e.g., about 300 mV with respect to the first electrode.

Consistent with FIG. 1C, the reagent layer 116 is not coated onto the first electrode 112, which causes the magnitude of the absolute peak current i_{pb} to be relatively low compared to the magnitude of the absolute peak current i_{pc}. The reagent layer 116 may be configured to generate a reduced mediator in a presence of an analyte, and the amount of the reduced mediator proximate to the second electrode may contribute to the relatively high absolute peak current i_{pc}. In one embodiment, at least the enzyme portion of the reagent layer 116 may be configured to not substantially diffuse from the second electrode to the first electrode when a sample is introduced into the test strip.

The test current after i_{pb} tends to settle to a flat region at approximately 1.3 seconds, and then the current increases again as the reduced mediator generated at the second electrode 114, which may be coated with the reagent layer 116, diffuses to the first electrode 112, which is not coated with the reagent layer 116. In one embodiment, a capacitance measurement may be performed at a relatively flat region of the test current values, which may be performed at about 1.3 seconds to about 1.4 seconds.

Generally, if the capacitance is measured before 1 second, then the capacitance measurement may interfere with the relatively low first test potential E₁ that may be used to measure the first current transient iₐ(t). For example, an oscillating voltage component on the order of 50 mV superimposed onto a 20 mV constant voltage component may cause significant perturbation of the measured test current. Not only does the oscillating voltage component interfere with the first test potential E₁, but it may also significantly perturb the test currents measured at about 1.1 seconds, which in turn may interfere with correction for antioxidants. Following a great deal of testing and experimentation, it was finally determined that, surprisingly, measuring the capacitance at about 1.3 seconds to about 1.4 seconds resulted in accurate and precise measurements that did not interfere with the control solution/blood discrimination test or the blood analyte (e.g., glucose) algorithm.

In the determination of analyte (blood glucose) and following the second test potential E₂, a third test potential E₃ (e.g., about −300 mV, as illustrated in FIG. 6) may be applied causing the test current to be measured at the second electrode 114, which may be coated with the reagent layer 116. As noted previously, the presence of a reagent layer on the second electrode may allow penetration of liquid between the spacer layer and the electrode layer, which may cause the electrode area to increase.

As illustrated in FIG. 6, in an exemplary embodiment a 109 Hz AC test voltage (50 mV peak-to-peak) may be applied for 2 cycles during the time interval tᵣₐₚ. The first cycle may be used as a conditioning pulse and the second cycle may be used to determine the capacitance. The capacitance estimate may be obtained by summing the test current over a portion of the alternating current (AC) wave, subtracting the direct current (DC) offset, and normalizing the result using the AC test voltage amplitude and the AC frequency. This calculation enables a measurement of the capacitance of the strip, which is dominated by the strip sample chamber when it is filled with a sample.

In one embodiment for an exemplary blood glucose assay, the capacitance may be measured by summing the test current over one quarter of the AC wave on either side of the point in time where the input AC voltage crosses the DC offset, i.e. when the AC component of the input voltage is zero (the zero crossing point). A derivation of how this translates to a measurement of the capacitance is described in further detail below. Equation 3 may show the test current magnitude as a function of time during the time interval t_{cap}:

i(t)=i₀+st+I sin(ωt+φ) (Equation 3)

where i₀+st represents the test current caused by the constant test voltage component. Generally, the DC current component is considered as changing linearly with time (due to the on-going glucose reaction generating ferrocyanide) and is thus represented by a constant iₒ, which is the DC current at time zero (the zero crossing point), and s, the slope of the DC current change with time. The AC current component is represented I sin(ωt+φ), where I is the amplitude of the current wave, ω is its frequency, and φ is its phase shift relative to the input voltage wave. The term co may also be expressed as 2πf, where f is the frequency of the AC wave in Hertz. The term I may also be expressed as shown in Equation 4:

$$I = \frac{V}{\vert Z \vert} \qquad ( Equation 4 )$$

where V is the amplitude of the applied voltage signal and |Z| is the magnitude of the complex impedance.

$$\vert Z \vert = \frac{R}{\sqrt{1 + {tan}^{2} ϕ}} = \frac{R}{\sqrt{1 + {ω}^{2} {R}^{2} {C}^{2}}} \qquad ( Equation 5 )$$

where R is the real part of the impedance and C is the capacitance.

Equation 3 may be integrated from one quarter wavelength before the zero crossing point to one quarter wavelength after the zero crossing point to yield Equation 6:

$${\int }_{- 1 / 4 f}^{1 / 4 f} i ( t ) = {{i}_{0} [ t ]}_{- 1 / 4 f}^{1 / 4} + {\frac{s}{2} [ {t}^{2} ]}_{- 1 / 4 f}^{1 / 4} + I {\int }_{- 1 / 4 f}^{1 / 4 f} sin ( ω t + ϕ ) , \qquad ( Equation 6 )$$

which may be simplified to Equation 7:

$${\int }_{- 1 / 4 f}^{1 / 4 f} i ( t ) = \frac{{i}_{0}}{2 f} + \frac{I sin ϕ}{π f} . \qquad ( Equation 7 )$$

By substituting Eq. 4 into Eq. 3, then into Eq. 6, and then rearranging, Equation 8 results:

$$C = \frac{1}{2 V} ( {\int }_{- 1 / 4 f}^{1 / 4 f} i ( t ) = \frac{{i}_{0}}{2 f} ) . \qquad ( Equation 8 )$$

The integral term in Equation 8 may be approximated using a sum of currents, as shown in Equation 9:

$${\int }_{- 1 / 4 f}^{1 / 4 f} i ( t ) \approx \frac{\frac{1}{n} {\sum }_{k = 1}^{n} {i}_{k}}{2 f} \qquad ( Equation 9 )$$

where the test currents iₖ are summed from one quarter wavelength before the zero crossing point to one quarter wavelength past the zero crossing point. Substituting Equation 9 into Equation 8 yields Equation 10:

$$C = \frac{\frac{1}{n} {\sum }_{k = 1}^{n} {i}_{k} - {i}_{0}}{4 Vf} , \qquad ( Equation 10 )$$

in which the DC offset current iₒ may be obtained by averaging the test current over one full sine cycle around the zero crossing point.

In another embodiment, the capacitance measurements may be obtained by summing the currents not around the voltage zero crossing point, but rather around the maximum AC component of the current. Thus, in Equation 9, rather than summing a quarter wavelength on either side of the voltage zero crossing point, the test current may be summed a quarter wavelength around the current maximum. This is tantamount to assuming that the circuit element responding to the AC excitation is a pure capacitor, so φ is approximately π/2. Thus, Equation 7 may be reduced to Equation 11:

$${\int }_{- 1 / 4 f}^{1 / 4 f} i ( t ) = \frac{{i}_{0}}{2 f} + \frac{I}{π f} . \qquad ( Equation 11 )$$

This is believed to be a reasonable assumption in this case as the uncoated electrode is polarized such that the DC, or real, component of the current flowing is independent of the voltage applied over the range of voltages used in the AC excitation. Accordingly, the real part of the impedance responding to the AC excitation is infinite, implying a pure capacitive element. Equation 11 may then be used with Equation 8 to yield a simplified capacitance equation that does not require an integral approximation. The net result is that capacitance measurements when summing the currents not around the voltage crossing point, but rather around the maximum AC component of the current, were more precise.

It has been determined that the various coatings 126 produce or alter the double layer capacitance measurement. As a result, a predetermined capacitance measurement may be assigned to the measurement device. This predetermined capacitance measurement device may be the capacitance value expected to be measured. The predetermined capacitance value may be a single value, or a range of values. For example, the predetermined capacitance value may be 600 nF. In another example, the predetermined capacitance value may be greater than 600 nF or less than 600 nF. The predetermined capacitance value is determined based on a characteristic of the electrode. More specifically, the predetermined capacitance value is determined based on a characteristic of the coating of the electrode, such as the molecular length of the coating. For example, if a MESA coating is used, the predetermined capacitance value may be greater than 600 nF and if the MPSA coating is used, the predetermined capacitance value may be less than 600 nF.

The analyte measurement device may compare this predetermined capacitance value to the measured capacitance value. By comparing the measured capacitance value to the predetermined capacitance value, the measurement device is able to determine if the inserted test strip is compatible with the device. To determine if the test strip is compatible, the measurement device determines if the measured capacitance value is equivalent to the predetermined capacitance value, which is stored by a processor of the device having suitable non-volatile memory. For example, if the predetermined capacitance value is a range, the measurement device determines if the measured capacitance value is within the range. In another example, if the predetermined capacitance value is a single value, the measurement device determines if the measured capacitance value is substantially equal to the predetermined value, such as ±10% of the predetermined capacitance value.

If the measurement device determines that the measured capacitance value is equivalent to the predetermined capacitance value, the measurement device determines that the test strip is compatible with the measurement device and proceeds with analyte analysis. However, if the measured capacitance value is not equivalent to the predetermined capacitance value, the measurement device determines that the test strip is not compatible with the measurement device. In this case, the measurement device does not proceed with analyte testing and may instead return an error message.

Because the measurement device is able to determine if a test strip is compatible with the measurement device via capacitance, a variety of test strips can be released. These test strips can be regionalized, such as for cost reasons. In another example, the test strips can have differences in designs. By matching the predetermined capacitance value with a particular meter type, it is possible to release a variety of test strips, while simultaneously impossible to use the incorrect strip with the meter type in which it was not meant to be tested.

FIG. 6 illustrates a flow chart of a method 600 of determining compatibility of a test strip with an analyte measurement device. At block 602, insertion of a test strip in an analyte measurement device is detected. The test strip can, for purposes of this embodiment, have a design similar to the test strip 100 illustrated in FIGS. 1A-1C. At block 604, a test potential is applied to the electrodes for a test potential time interval to measure capacitance of the test strip. At block 606, a capacitance value of the test strip is measured. At block 608, the measured capacitance value is compared to a predetermined capacitance value. At block 610, the analyte measurement device determines, based on comparison of the measured capacitance value and the predetermined capacitance value, compatibility of the test strip with the analyte measurement device.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “circuitry,” “module,” ‘subsystem” and/or “system.” Furthermore, aspects of the present invention may take the form of a computer program product embodied in one or more computer readable medium(s) having computer readable program code embodied thereon.

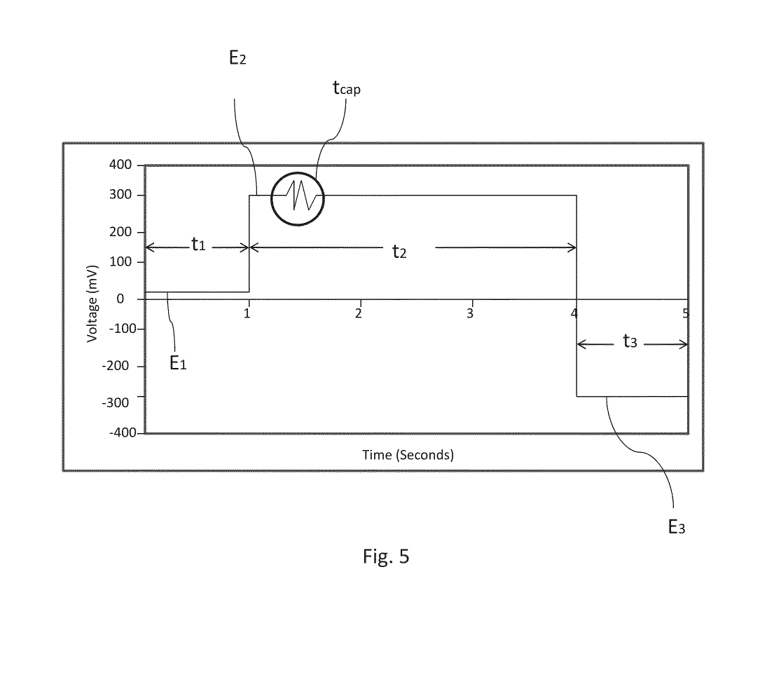

### PARTS LIST FOR FIGS. 1A-6

100 test strip
102 distal end
104 proximal end
106 lateral edge
108 lateral edge
110 sample reaction chamber
112 first electrode
114 second electrode
116 reagent
118 spacer layer
120 cutout area
122 ports
124 electrical contacts
126 coating
402 strip port connector
404 contact (bottom electrode interface)
406 contact (bottom electrode interface)
408 center contact (top electrode interface)
410 spacer gap
412 test strip
414 internal hard stop
416 pinch point
600 method
602 step—detect test strip insertion
604 step—apply test potential
606 step—measure capacitance
608 step—compare measured and predetermined capacitance
610 step—determine test strip compatibility

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. An analyte measurement system, comprising:
a test strip, comprising:
at least two electrodes spaced apart in a reaction chamber, one of said electrodes comprising a conductive material having a coating applied thereupon; and
an analyte measurement device, comprising:
a strip port having connectors configured to couple to the electrodes of the test strip;
in which the applied coating enables a capacitance value of the test strip to be measured in order to determine compatibility of the test strip with the analyte measurement device.

2. The analyte measurement system of claim 1, wherein the applied coating does not affect determination of at least one analyte by the analyte measurement device.

3. The analyte measurement system of claim 1, wherein the analyte measurement device is configured to determine compatibility of the test strip by comparing the measured capacitance value with a predetermined capacitance value.

4. The analyte measurement system of claim 1, wherein capacitance of the test strip is directly related to a molecular length of the coating.

5. The analyte measurement system of claim 1, wherein capacitance of the test strip varies based on a molecular length of the coating.

6. The analyte measurement system of claim 1, wherein the coating comprises a molecule comprising a carbon alky chain, the carbon alkyl chain comprising at least three carbon atoms.

7. A test strip for an analyte measurement device, comprising:
at least two electrodes spaced apart in a test chamber in which a first electrode comprises a conductive material having a coating thereupon,
the coating comprising a thiol molecule comprising an alkyl chain comprising at least three carbon atoms.

8. The test strip of claim 7, wherein the thiol molecule comprises an alkyl thiol.

9. The test strip of claim 7, wherein the thiol molecule comprises sodium-2-mercaptopropane sulfonate (MPSA).

10. The test strip of claim 7, wherein the thiol molecule comprises sodium-2-mercaptobutane sulfonate (MBSA).

11. The test strip of claim 7, wherein the thiol molecule comprises a molecular length substantially greater than 5.108 Å.

12. The test strip of claim 7, wherein the thiol molecule comprises a molecular length substantially greater than 6.86 Å.

13. The test strip of claim 7, wherein capacitance of the test strip is directly related to molecular length of the thiol molecule.

14. The test strip of claim 7, wherein as molecular length of the thiol molecule increases, capacitance of the test strip decreases.

15. The test strip of claim 7, wherein a capacitance value of the test strip is less than 600 nF.

16. A method for determining test strip compatibility with an analyte measurement device, comprising:
detecting, in an analyte measurement device, insertion of a test strip in the analyte measurement device, the test strip comprising at least two electrodes in a spaced apart configuration;
applying a test potential between the electrodes for a predetermined time interval;
measuring a capacitance value;
comparing the measured capacitance value to a predetermined capacitance value; and
determining, based on comparison of the measured capacitance value and the predetermined capacitance value, the compatibility of the test strip with the analyte measurement device.

17. The method of claim 16, wherein determining compatibility of the test strip with the analyte measurement device comprises determining if the measured capacitance value is substantially equal to the predetermined capacitance value.

18. The method of claim 17, wherein if the measured capacitance value is substantially equal to the predetermined capacitance value, the test strip is compatible with the analyte measurement device.

19. The method of claim 17, wherein the measured capacitance value is substantially equal to the expected capacitance value if the measured capacitance value is within a predetermine range about the predetermined capacitance value.

20. The method of claim 19, wherein the measured capacitance value is substantially equal to the expected capacitance value if the measured capacitance value is within 10% of the predetermined capacitance value.
